(19) United States
(12) Patent Application Publication
(10) Pub. No.: US 2001/0021729 A1
(43) Pub. Date: Sep. 13, 2001

(54) Incorporating high levels of magnetic particulate into the rubber matrix of rubber compounds

(76) Inventors: Frank P. Papp, Charlotte, NC (US); Duane M. Oxley, Fort Mill, SC (US); James M. Giustino, Waxhaw, NC (US)

Correspondence Address: CALFEE HALTER & GRISWOLD, LLP, 800 SUPERIOR AVENUE, SUITE 1400, CLEVELAND, OH, 44114, US

(21) Appl. No.: 09/785,801

(22) Filed: Feb. 16, 2001

(51) Int. Cl. G11B 5/62

(52) U.S. Cl. 523/181

(57) ABSTRACT

A composition useful for magnetic filled tires, particularly for tire sidewalls, which contains an orsganoxysilylsulfane coupling agent, is provided. The composition displays either improved fatigue resistance or either improved crack growth resistance or both. The sidewall composition is magnetizable to a magnetic field strength of preferably at least 0.1 Gauss, more preferably at least 0.5 Gauss, even more preferably at least 1 Gauss, even more preferably at least 10 Gauss, most preferably at least 25 Gauss, as measured at a distance of 8 mm for a 1 mm thick layer. The sidewall composition comprises 100 parts rubber, magnetic particulate, organosilane and curing agents. The compositions contain: curing agents in an amount effective to cure the rubber; such as sulfur preferably from 30 to 350 phr, more preferably from 40 to 300 phr, most preferably from 50 to 250 phr magnetic particulate; and preferably from 0.5 phr to 30 phr, more preferably from 1 phr to 20 phr, most preferably from 2 to 10 phr organoxysilylsulfane. The present invention also relates to methods of making tires, and to the tire itself.

This application claims priority to U.S. provisional application Ser. No. 60/183,561, filed Feb. 18, 2000, entitled “Incorporating High Levels of Magnetic Particulate into the Rubber Matrix of Rubber Compounds”.

### BACKGROUND OF THE INVENTION

Modern vehicles are often equipped with a Sidewall Torsional Sensor System which detects longitudinal and lateral forces acting upon the tires. The tires, which contain magnetic particulate dispersed in the sidewall, provide a magnetic signal to the Sidewall Torsional Sensor System, which in turn provides the onboard vehicle computer with immediate information about the forces acting on the tires. However, to produce a suitable magnetic signal, the magnetic particulate is added in significant amounts. The presence of the magnetic particulates however results in significant loss of fatigue resistance and crack growth resistance.

It would be desirable to have a composition for use in vehicle tires, which provides a signal to Sidewall Torsional Sensor System, but which does not display poor fatigue resistance and crack growth resistance.

### SUMMARY OF THE INVENTION

The present invention provides a composition useful for magnetic filled tires, particularly for tire sidewalls, which contains an organoxysilylsulfane coupling agent. The composition displays either improved fatigue resistance and preferably improved crack growth resistance. The sidewall composition is magnetizable to a magnetic field strength of preferably at least 0.1 Gauss, more preferably at least 0.5 Gauss, even more preferably at least 1 Gauss, even more preferably at least 10 Gauss, most preferably at least 25 Gauss, as measured at a distance of 8 mm for a 1 mm thick layer. The sidewall composition preferably has: the following physical properties: 1. a fatigue to failure value at 101% extension of 142 cycles to failure or greater, more preferably 200 cycles to failure or greater, more preferably 266 cycles to failure or greater; 2. a fatigue to failure value at 136% extension of 47 cycles to failure or greater, more preferably 67 cycles to failure or greater, more preferably 100 cycles to failure or greater; 3. a pierced DeMattia resistance of 12 KC/mm or greater, more preferably 15 KC/mm or greater, even more preferably 29 KC/mm or greater. Preferably, the sidewall composition has two or more of the preceding physical properties.

The sidewall composition comprises 100 parts rubber, magnetic particulate, organosilane and curing agents. The amounts of ingredients are based upon 100 parts rubber. The compositions contain: curing agents in an amount effective to cure the rubber; preferably from 1.2 to 3.75, more preferably from 1.35 to 3.45 even more preferably from 1.5 to 3.13 phr curing agents such as sulfur, more preferably 1.5 to 2.5 phr soluble sulfur and 1.88 to 3.13 oil treated sulfur; preferably from 30 to 350 phr, more preferably from 40 to 300 phr, most preferably from 50 to 250 phr magnetic particulate; and preferably from 0.5 phr to 30 phr, more preferably from 1 phr to 20 phr, most preferably from 2 to 10 phr organoxysilylsulfane. Conventional rubber additives are optionally added.

The present invention also relates to methods of making tires, and to the tire itself. In the first method, the sidewall composition is prepared by providing 100 parts rubber and preferably from 30 to 350 phr, more preferably from 40 to 300 phr, most preferably from 50 to 250 phr magnetic particulate; and preferably from 0.5 phr to 30 phr, more preferably from 1 phr to 20 phr, most preferably from 2 to 10 phr organoxysilylsulfane; combining the rubber with 15% to 50%, preferably 20% to 30%, more preferably 25% of the magnetic particulate to form a first mixture, then the first mixture is combined with 25%-75%, preferably 45% to 55%, more preferably 50% of the organoxysilylsulfane and 15%-50%, preferably 20% to 30%, more preferably 25% of the magnetic particulate to form a second mixture; then the remaining 25% to 75%, preferably 45% to 55%, more preferably 50% of the magnetic particulate, 25% to 75%, preferably 45% to 55%, more preferably 50% of the organoxysilylsulfane, are added to the second mixture. Preferably carbon black is added; the carbon black is added at any stage, preferably to the first mixture. Lastly the curing agents are added.

In the second method, the sidewall composition is prepared by providing 100 parts rubber and preferably from 30 to 350 phr, more preferably from 40 to 300 phr, most preferably from 50 to 250 phr magnetic particulate; and preferably from 0.5 phr to 30 phr, more preferably from 1 phr to 20 phr, most preferably from 2 to 10 phr organosilane; combining the rubber with 50% to 100%, preferably 90% to 100% of the organoxysilylsulfane and 25% to 75%, preferably 45% to 55%, more preferably 50% of the magnetic particulate to the rubber to form a first mixture. Then the remaining 25% to 75%, preferably 45% to 55%, more preferably 50% of the magnetic particulate, and 0 to 50%, preferably 0% to 10% of the organoxysilylsulfane, are added to the first mixture to form a second mixture. Preferably carbon black is added; the carbon black is added at any stage, preferably it is added to the first mixture. Lastly, the curing agents are added.

### BRIEF DESCRIPTION OF THE FIGURES

FIG. 1 is a graph showing the fatigue until failure, in cycles to failure, with two different extensions of the composition of Examples 1 to 4, compared to conventional compositions of Comparative Examples A and B;

FIG. 2 is a graph showing the fatigue until failure, with two different extensions of the composition of Examples 1 to 4, compared to conventional compositions of Comparative Examples A and B (using normalized data);

FIG. 3 is a graph showing the Pierced DeMattia Crack Growth Resistance of the composition of Examples 1 to 4, compared to conventional compositions of Comparative Examples A and B. The units “KC/mm” represents kilocycles per millimeter. Kilocycles means thousand cycles of uploading and downloading; this number is divided by the length, in millimeters, of the resulting crack in the samples;

FIG. 4 is a graph showing the Pierced DeMattia Crack Growth Resistance of the composition of Examples 1 to 4, compared to conventional compositions of Comparative Examples A and B using normalized data;

FIG. 5 is a graph showing the Fatigue resistance in cycles to failure, of the composition of Examples 5 and 6, compared to conventional compositions of Comparative Examples A and B;

FIG. 6 is a graph showing the Fatigue resistance in cycles to failure, of the composition of Examples 5 and 6, compared to conventional compositions of Comparative Examples A and B using normalized data;

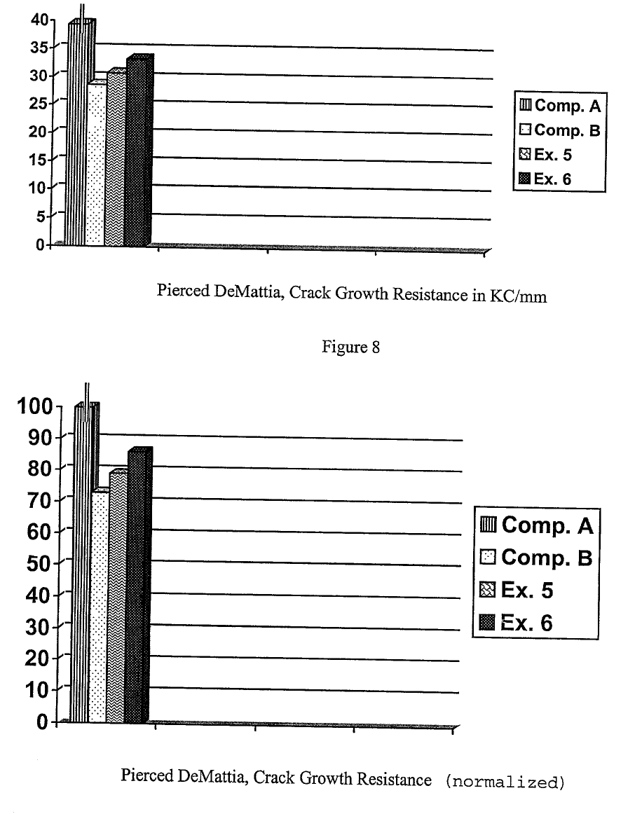

FIG. 5 is a graph showing the Pierced DeMattia Crack Growth Resistance of the composition of Examples 1 to 4, compared to conventional compositions of Comparative Examples A and B;

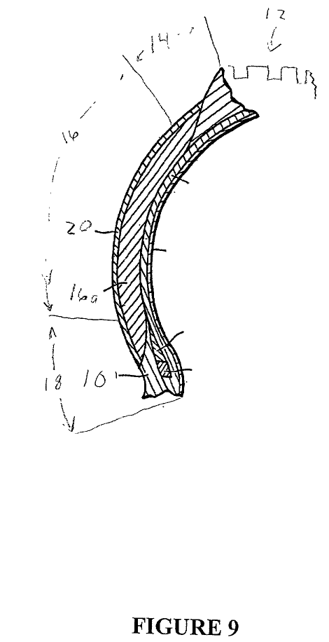

FIG. 6 is a graph showing the Pierced DeMattia Crack Growth Resistance of the composition of Examples 1 to 4, compared to conventional compositions of Comparative Examples A and B using normalized data; and

FIG. 7 is shows a tire in cross section, with a sidewall veneer containing the sidewall composition.

### DETAILED DESCRIPTION OF THE INVENTION

The present invention provides a composition useful for magnetic tires, particularly for magnetic tire sidewalls, which contains an organoxysilylsulfane coupling agent. The composition displays either improved fatigue resistance or either improved crack growth resistance or both.

The sidewall composition preferably has: the following physical properties: 1. a fatigue to failure value at 101% extension of 142 cycles to failure or greater, more preferably 200 cycles to failure or greater, more preferably 266 cycles to failure or greater; 2. a fatigue to failure value at 136% extension of 47 cycles to failure or greater, more preferably 67 cycles to failure or greater, more preferably 100 cycles to failure or greater; 3. a pierced DeMattia resistance of 12 KC/mm or greater, more preferably 15 KC/mm or greater, even more preferably 29 KC/mm or greater. Preferably, the sidewall composition has two or more of the preceding physical properties.

The sidewall composition comprises rubber, magnetic particulate, organoxysilylsulfane and curing agents. Conventional additives are optionally added.

The amounts of ingredients are based upon 100 parts rubber. Preferably the 100 parts rubber is comprised of from 20% to 70% natural rubber, from 20% to 70% butadiene rubber, 0% to 30%, preferably from 10% to 30 emulsion styrene butadiene rubber.

In addition to the rubber, the sidewall compositions contain: curing agents in an amount effective to cure the rubber. Preferably there is from 1.2 to 3.75, more preferably from 1.35 to 3.45, even more preferably from 1.5 to 3.13 phr curing agents such as sulfur, more preferably 1.5 to 2.5 phr soluble sulfur and 1.88 to 3.13 oil treated sulfur. The sidewall composition also contain preferably from 30 to 350 phr, more preferably from 40 to 300 phr, most preferably from 50 to 250 phr magnetic particulate and preferably from 0.5 phr to 30 phr, more preferably from 1 phr to 20 phr, most preferably from 2 to 10 phr organoxysilylsulfane.

Other additives which are conventionally used in sidewall compositions are optionally added. Preferably the sidewall composition contains from 0 to 100, preferably from 0.1 to 100, more preferably from 10 to 80, even more preferably from 15 to 70, most preferably from 25 to 60 phr carbon black.

Preferably, though optionally, the sidewall composition also contains: from 0 to 8, preferably from 0.1 to 8, more preferably from 0.2 to 2, even more preferably from 0.3 to 1.5 phr cure accelerators; from 0 to 40, preferably from 0.1 to 40, more preferably from 4 to 22, even more preferably from 8 to 20 phr processing oil; from 0 to 20, preferably from 0.1 to 20, more preferably from 1 to 12, even more preferably from 4 to 10 phr antidegradant; from 0 to 16, preferably from 0.1 to 16, more preferably from 0.25 to 8, even more preferably from 2 to 6 phr waxes such as microcrystalline waxes; from 0 to 16 preferably from 0.1 to 16, more preferably from 0.5 to 8, even more preferably from 2 to 6 phr zinc oxide; from 0 to 12, preferably from 0.1 to 12, more preferably from 0.25 to 4, even more preferably from 1 to 4 phr stearic acid; and from 0 to 16, preferably 0.1 to 16 phr, more preferably from 0.25 to 8, more preferably from 1 to 6, tackifying agents.

The Rubber

Conventional rubbers used to form tire sidewalls such as natural rubber, butadiene rubber, styrene butadiene rubber ethylene propylene diene monomer halobutyl rubber, and mixtures thereof are employed. Polybutadiene is commercially available Taktene 1203G1 Bayer, Orange, Tex., Cisdene 1203 from American Synthetic Rubber, Louisville, Ky., Budene 1208 from Goodyear Chemical, Beaumont, Tex. and Buna CB25 from Bayer, Orange, Tex. Preferably silicone rubber is not employed.

100 parts of rubber are used. Preferably the 100 parts rubber is comprised of from 20% to 70% natural rubber, from 20% to 70% butadiene rubber, 0% to 30%, preferably from 10% to 30 emulsion styrene butadiene rubber.

The Magnetic Particulate

The magnetic particulate is a ferromagnetic material having a coercivity value, that is a resistance to demagnetization measured in Kiloamperes per meter hereinafter “KA/m”. The magnetic particulate preferably has a coercivity value of at least 30 KA/m, more preferably 50 KA/m, even more preferably at least 70 KA/m, most preferably at least 100 KA/m. Materials having a coercivity of less than 50 KA/m will readily demagnetize so that the tire no longer provides a signal to the Torsional Sensor System.

The magnetic particulate is selected from ferromagnetic elements such as iron, cobalt, nickel, gadolinium, dysprosium and alloys and compounds thereof. Mixtures of magnetic particulates are also used. Preferred magnetic particulates are ferrites such as for example the following: NiFe₂O₄, Zn_{0.7}Ni_{0.3}Fe₂O₄, Zn_{0.2}Mn_{0.6}Fe_{2.2}O₄, CoₓFe₃₋ₓO₄, MnFe₂O₄, CdₓNi₁₋ₓFe₂O₄, Li_{0.5}Fe_{0.5}FeO₄, CoFe₂O₄, BaFe₁₂O₁₉, SrFe₁₂O₁₉, Y3Fe₅O₁₂, MgFe₂O₄, CuFe₂O₄.

Particularly preferred is strontium ferrite, even more particularly tetrahedral strontium ferrite and octahedral strontium ferrite. Preferably the magnetic particulate has a particle size from 0.25 to 25 microns, more preferably from 0.5 to 10 microns, even more preferably from 0.75 to 5 microns, most preferably from 1 to 1.5 microns. Good results have been obtained using 1.4 micron powdered strontium ferrite available under the trade name Starbond Ferrite Powder HM181 from Hoosier Magnetics, Washington, Ind.

While barium ferrite is suitable, it is less preferred due to environmental concerns. Iron powder is also less preferred due to its rapid oxidation. Iron oxides are much less preferred because they do not bond well with organosilanes and are have low coercivity that is they are easily demagnetized.

The magnetic particulate is present in an amount sufficient to generate a signal detectable by Sidewall Torsional Sensor Systems.

The sidewall composition is magnetizable to a magnetic field strength of preferably at least 0.1 Gauss, more preferably at least 0.5 Gauss, even more preferably at least 1 Gauss, even more preferably at least 10 Gauss, most preferably at least 25 Gauss, as measured at a distance of 8 mm for a 1 mm thick layer. The magnetic composition and the tire having a sidewall with the magnetic composition, have a magnetic field strength of preferably at least 0.1 Gauss, more preferably at least 0.5 Gauss, even more preferably at least 1 Gauss, even more preferably at least 10 Gauss, most preferably at least 25 Gauss, as measured at a distance of 8 mm for a 1 mm thick layer.

Magnetic field strength in a tire sidewall is measured by rotating the tire for example at 4096 points per revolution using a conventional sensor at a distance of 8 mm such as a Hall effect sensor. The sensor detects the amplitude and frequency; the amplitude is the magnetic field strength. A Helmholtz coil is used for calibration. A Hall effect sensor is available commercially for example from LDJ Electronics.

The Organoxysilylsulfane

The organooxysilyl sulfane, is preferably an ethoxy silyl sulfane, more preferably a triethoxysilyl sulfane. Preferably the organoxysilylsulfane has the following structure:

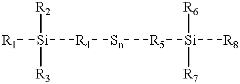

wherein:

R₁ is and ethoxy methoxy or hydroxy group;

R₂ is H ethoxy methoxy or hydroxy group;

R₃ is H ethoxy methoxy or hydroxy group;

R₄ is an alkyl group having at least 1 carbon atom, preferably from

1 to 40, more preferably 1 to 8 carbon atoms;

Rs is an alkyl group having at least 1 carbon atom, preferably from

1 to 40, preferably 1 to 4 carbon atoms;

R₆ is H, ethoxy, methoxy, or hydroxy group;

R₇ is H, ethoxy, methoxy, or hydroxy group;

R₈ is H, ethoxy, methoxy, or hydroxy group;

n is a number from 1 to 20, preferably 1 to 8, most preferably 1 to 5.

Preferably the organoxysilylsulfane is nonpolymeric. The most preferred organoxysilylsulfanes are triethoxysilylpropyl disulfane hereinafter also referred to as “TESPD”, shown below:

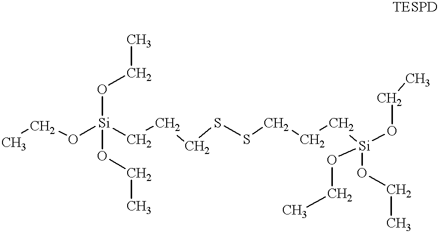

and Bis-(triethoxysilylpropyl) tetrasulfane, hereinafter also referred to as “TESPT”, shown below:

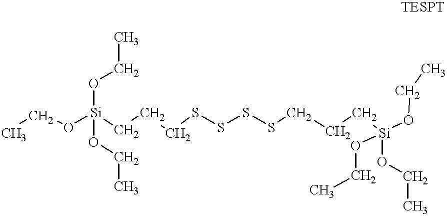

TESPT is commercially available as Activator X50S from: Degussa-Huels, AG, Kalsscheuren, Germany; Degussa Corp., Belpre, Ohio: and TESPD commercially available as Silquest A1589 fromn C. K. Witco, Organosilanes Group, Inchem Plant, Rock Hill, S.C.

The organoxysilylsulfane is added to the sidewall composition in an amount effective to improve fatigue resistance or crack propagation resistance or both. The ratio of the magnetic particulate to the organoxysilylsulfane is 10:1 to 100:1, preferably 25:1 to 75:1, more preferably 45:1 to 55:1.

The Curing Agents

The curing agents are conventional in the rubber industry. Good results have been obtained with curing agents such as sulfur, for example soluble sulfur commercially available as Royal RM 90, 0.5% OT from Reagent Chemical, Middlesex, NJ or 20% oil treated sulfur available as Crystex HS OT 20 from Flexsys, Monongahela, Pa.

The Optional Additives

The optional additives are conventional in sidewall compositions. A variety of ingredients are typically, although not necessarily employed in sidewall composition such as, for example, processing oils to reduce viscosity, such as, for example, an aromatic oil available under the trade name Sundex 8125 from Sunoco, Inc., Tulsa, Okla. or napthenic oil, and antidegradants such as for example P-phenylenediamine antedegradants such as Flexzone 4L, from Uniroyal Chemical, Elmira, Ont, Canada and Santoflex 6PPD PST from Flexsys, Sauget, Ill. Examples of other optional ingredients are waxes such as microcrystalline waxes, such as for example, Micro crystalline paraffin wax available under the trade name Okerin 2027 from Allied Signal Specialty Chemicals, Titusville, Pa., and tackifying agents. Preferably the tackifying agents are tackifying resins, such as for example phenolic resins such as the phenolic resin commercially available as HRJ 10420 from Schenectady International, Inc., Rotterdam Junction, N.Y. and hydrocarbon resins Escorez 1102 from Exxon Mobil, Baton Rouge, La., Norsolene S95 from Totalfina, Channelview, Tex. and mixtures thereof. Curing accelerators such as 2-Benzothiazolesulfenamide, N-tert-butyl- also known as TBBS accelerator, commercially available as Delac NS Millipellets from Uniroyal Chemical, Geismer, La. and 2-Benzothiazolesulfenamide, N-cyclohexyl- also known as CBS accelerator, commercially available as Delac S Millipellets from Uniroyal Chemical, Geismer, La. are also optionally employed.

Activators such as zinc stearate formed from the reaction of zinc oxide commercially available as Kadox 720 from Zinc Corporation of America, Monaca, Pa. and stearic acid commercially available as Industrene R Flake from Witco, Mapleton, Ill., are optionally employed.

Carbon black is also optionally added. Good results have been obtained using carbon black available under the designations N660 from Degussa, Aransas Pass, Tex., and Continex N550 from Alexandria Carbon Black Co, Alexandria, Egypt.

Preferably the magnetic sidewall composition contains less than 10%, more preferably less than 5%, even more preferably less than 1% most preferably 0% silica fillers.

### Methods of Making the Magnetic Sidewall Composition

Method 1

Generally, the sidewall composition is prepared by providing 100 parts rubber and from 30 to 350, preferably from 40 to 300, more preferably from 50 to 250 phr magnetic particulate and from 0.5 to 30, preferably from 1 to 20, more preferably from 1 to 20 phr organoxysilylsulfane; combining the rubber with 15% to 50%, preferably 20% to 30%, more preferably 25% of the magnetic particulate to form a first mixture, then the first mixture is combined with 25%-75%, preferably 45% to 55%, more preferably 50% of the organoxysilylsulfane and 15%-50%, preferably 20% to 30%, more preferably 25% of the magnetic particulate to form a second mixture; then the remaining 25% to 75%, preferably 45% to 55%, more preferably 50% of the magnetic particulate, 25% to 75%, preferably 45% to 55%, more preferably 50% of the organoxysilylsulfane, are added to the second mixture. Preferably carbon black is added; the carbon black is added at any stage, preferably to the first mixture. Lastly the curing agents are added.

Preferably, a side wall composition is prepared by providing 100 parts rubber and from 30 to 350, preferably from 40 to 300, more preferably from 50 to 250 phr magnetic particulate and from 0.5 to 30, preferably from 1 to 20, more preferably from 1 to phr organoxysilylsulfane; first forming a first masterbatach by adding the rubbers to a mixer. Good results have been obtained using a Banbury mixer at 50° C. and at 77 to 116 rpm. Next, preferably from 5% to 75%, more preferably from 15% to 50%, most preferably from 20% to 30%, of the magnetic particulate, is added along with the tackifying resin, filler preferably carbon black, and the antidegradants, and then thoroughly mixing. Next, the wax, preferably microcrystalline wax, stearic acid, from 5% to 75%, more preferably from 15% to 50%, most preferably from 20% to 30%, of the magnetic particulate, and preferably from 20% to 80% more preferably from 30% to 70%, most preferably from 40% to 60% of the organosilane, are added and thoroughly mixed. The aromatic oil is then added and mixed. Good results have been obtained by discharging and cooling to provide a first masterbatch.

A second masterbatch is formed by adding the first masterbatch, the remaining magnetic particulate and the remaining organosilane, and mixing. Good results have been obtained by discharging and cooling.

Then second masterbatch is added to the mixer, the curative agents are added and the composition is mixed, then discharged.

Method 2

Generally, the sidewall composition is prepared by providing 100 parts rubber and from 30 to 350, preferably from 40 to 300, more preferably from 50 to 250 phr magnetic particulate and from 0.5 to 30, preferably from 1 to 20, more preferably from 1 to 20 phr organoxysilylsulfane; combining the rubber with 50% to 100%, preferably 90% to 100% of the organoxysilylsulfane and 25% to 75%, preferably 45% to 55%, more preferably 50% of the magnetic particulate to the rubber to form a first mixture. Then the remaining 25% to 75%, preferably 45% to 55%, more preferably 50% of the magnetic particulate, and 0 to 50%, preferably 0% to 10% of the organoxysilylsulfane, are added to the first mixture to form a second mixture. Preferably carbon black is added; the carbon black is added at any stage, preferably it is added to the first mixture. Lastly, the curing agents are added.

Preferably the sidewall composition is prepared by providing 100 parts rubber and from 30 to 350, preferably from 40 to 300, more preferably from 50 to 250 phr magnetic particulate and from 0.5 to 30, preferably from 1 to 20, more preferably from 1 to 20 phr organoxysilylsulfane; adding the rubbers to a mixer. Good results have been obtained using a Banbury mixer at 50° C. and at 77 to 116 rpm. Next, from preferably from 20% to 80% more preferably from 30% to 70%, most preferably from 40% to 60% of the magnetic particulate and preferably from 80% to 100%, more preferably 100% of the organoxysilylsulfane are added and mixed. Then the filler preferably carbon black, the tackifying resin, microcrystalline paraffin wax, stearic acid, magnetic particulate, organoxysilylsulfane, were added and mixed. Then 50% of the aromatic oil was added, mixed, discharged and cooled.

A second masterbatch is formed by adding the first masterbatch, then adding carbon black, zinc oxide, the remainder of the magnetic particulate and the remaining 50% of the aromatic oil and then mixed and discharged. The second masterbatch is added to the mixer and the curative agents are added. The material is discharged and cooled.

The sidewall composition is then used to form a tire, preferably a veneer tire. For example, see: U.S. Pat. No. 5,895,854 issued Apr. 20, 1999 to Thomas Becherer entitled “Vehicle Wheel Provided with a Pneumatic Tire having therein a Rubber Mixture Permeated with Magnetizable Particles”; U.S. Pat. No. 5,923,240 to Drahne, issued Jun. 15, 1999 entitled “Method and Device for controlling Slip and/or for Determining the Longitudinal force or flex Work-Proportional Parameter and Vehicle Tire Therefore; and U.S. Pat. No. 5,926,017 to Von Grunberg, issued U.S. Pat. No. 5,926,017 entitled “Device for Measuring the Rotary Frequency of a Rotating Vehicle Wheel and Vehicle Tire for Use in the Device”; each which is fully incorporated herein by reference.

Referring to FIG. 7, a vehicle tire 10 is shown in cross section having a tread 12, a shoulder 14 extending from the tread to sidewall 16. The bead 18 extends from the sidewall 16. Veneer 20 is present atop the inner sidewall 16a. The sidewall veneer is applied using conventional techniques such as for example lamination or co-extrusion. In an alternative embodiment not shown, the veneer 18 is not present and the sidewall 16 is comprised of the sidewall composition.

### EXAMPLES

### Example 1

A side wall composition was prepared by adding 40 phr natural rubber, 60 phr high cis polybutadiene rubber, within 15 seconds to a Danbury mixer 50 C 77rpm. Next, 50 phr, that is, one fourth of the strontium ferrite, 3 phr tackifying resin, 48 phr N660 carbon black, 2.2 phr, Flexzone 4L, N,N′-di-(1,4-dimethylpentyl)-p-phenylenediamine, and 7.4 phr Santoflex 6PPD PST, N-(1,3-dimethyl-butyl)-N′-phenyl-p-phenylenediamine (9.6 phr total antidegradants), 2.7 phr zinc oxide, were added at 1 minute between 77 and 116 rpms. Next, 2.2 phr microcrystalline wax, 2 phr stearic acid, 50 phr strontium ferrite and 2 phr of the triethoxy silyl propyl tetrasulfane hereinafter also “TESPT”, were added at 2 minutes. The 12 PHR aromatic oil was added at 3 minutes, followed by a clean and sweeping of the ram at 4 minutes at 116 rpm. The material was discharged at 149° C. to provide the first masterbatch. The maximum mixing cycle was 6 minutes.

A second masterbatch was formed by adding the first masterbatch, ramming down at 77 to 116 rpms, then adding 4 phr N660 Carbon black, 4 phr aromatic oil and 100 phr strontium ferrite and 2 phr TESPT at 1 minute and discharging at 149° C. The maximum mixing cycle was 4 minutes.

Starting at 50° C. one half of the second masterbatch was added to the mixer, then the curative agents, specifically 0.5 phr TBBS accelerator, and 1.92 phr soluble sulfur, were added followed by the remaining one half of the second masterbatch, added at 77 rpm. The material was rammed down by 30 seconds at 77 rpm. The material was discharged at 93.3° C. The maximum mixing cycle was 2.5 minutes.

### Example 2c

A side wall composition was formulated as in example 1, except that 3 phr TESPT rather than 2phr was added each time.

### Example 3 d

A side wall composition was formulated as in example 1, except that 4 phr TESPT rather than 2phr was added each time.

### Example 4

A side wall composition was formulated as in example 1, except that 2phr triethoxy silyl propyl disulfane hereinafter also “TESPD” was used instead of the TESPT.

### Example 5

The composition was prepared by adding 40 phr natural rubber, 60 phr high cis polybutadiene rubber within 15 seconds to a Banbury mixer 50° C., 77 rpm. Next, 100 phr strontium ferrite and 4 phr TESPD were added at 45 seconds between 77 and 116 rpm. Then 48 phr N660 carbon black, 3 phr a tackifying resin, 2.2 phr, Flexzone 4L, N,N′-di-(1,4-dimethylpentyl)-p-phenylenediamine, and 7.4 phr Santoflex 6PPD PST, N-(1,3-dimethyl-butyl)-N′-phenyl-p-phenylenediamine (9.6 phr total antidegradants), 2.2 phr microcrystalline paraffin wax, 2 phr stearic acid, 100 phr strontium ferrite, 4 phr TEPSD, were added at 1 minute 15 seconds. Then 12 phr aromatic oil was added at 2 minutes, followed by a clean and sweeping of the ram at 2 minutes and 45 seconds at 116 rpm. The material was discharged at 149° C. The maximum mixing cycle was 6 minutes.

A second masterbatch was firmed by adding the first masterbatch, ramming down at 77 to 116 rpm, then adding 4 phr carbon black, 2.7 phr zinc oxide, 100 phr strontium ferrite and the 4 phr aromatic oil at 35 to 45 seconds and discharging at 149° C. The maximum mixing cycle was 4 minutes.

Starting at 50° C. the second masterbatch was added to the mixer and curative agents, specifically 0.5 phr TBBS accelerator, and 1.92 phr soluble sulfur, were added at 77 rpm. The material was rammed down by 30 seconds at 77 to 116 rpm. The material was discharged at 93.3° C. The maximum mixing cycle was 2.5 minutes.

### Example 6

A composition was prepared as in example 4, except that 6 TESPD was used each time instead of 4 phr.

### Example 7

A composition was prepared as in example 4, except that 4 phr silica was also added.

### Example 8

A composition was prepared as in example 4, except that 8 phr silica was also added and 3 phr rather than 2 phr TESPD was added.

### Example 9

A composition was prepared as in example 5, except that 8 phr silica was also added and 3 phr rather than 2 phr was used.

### Comparative Example A

A conventional sidewall composition was prepared according to example 1 except that the TESPT and strontium ferrite were not used and the other ingredients were present as follows: 55 phr natural rubber, 45 phr high cis br butadiene rubber, 52 phr N660 carbon black, 16 PHR aromatic oil, 3 phr tackifying resin, 4.8 phr antidegradants, 2.2 phr microcrystalline paraffin wax, 2.7 phr zinc oxide, 2 phr stearic acid, 0.5 phr TBBS accelerator and 1.92 soluble sulfur.

### Comparative Example B A conventional side wall composition was formulated as in Example 1, except that no organoxysilylsulfane was used.

### Comparative Example C A conventional side wall composition was formulated as in Example 5, except that no organoxysilylsulfane was used.

The ingredients used in Examples 1 to 4 and Comparative Examples A and B are summarized below in Table A.

TABLE A

| | | Comp. | | | | |
|---|---|---|---|---|---|---|
| | Comp. | Ex. B | Ex. | Ex. | Ex. | Ex. |
| Ingredient | Ex. A | A | 1 B | 2 C | 3 D | 4 E |
| First Pass | PHR | PHR | PHR | PHR | PHR | PHR |
| NR | 55 | 40 | 40 | 40 | 40 | 40 |
| High Cis BR | 45 | 60 | 60 | 60 | 60 | 60 |
| N660 Carbon | 52 | 48 | 48 | 48 | 48 | 48 |
| Black | | | | | | |
| Aromatic Oil | 16 | 12 | 12 | 12 | 12 | 12 |
| Tackifying | 3 | 3 | 3 | 3 | 3 | 3 |
| Resin | | | | | | |
| Antidegradants | 4.8 | 9.6 | 9.6 | 9.6 | 9.6 | 9.6 |
| Micro | 2.2 | 2.2 | 2.2 | 2.2 | 2.2 | 2.2 |
| crystalline | | | | | | |
| paraffin Wax | | | | | | |
| Zinc Oxide | 2.7 | 2.7 | 2.7 | 2.7 | 2.7 | 2.7 |
| Stearic Acid | 2 | 2 | 2 | 2 | 2 | 2 |
| Strontium | — | 100 | 100 | 100 | 100 | 100 |
| Ferrite | | | | | | |
| TESPT | — | — | 2 | 3 | 4 | — |
| TESPD | — | — | — | — | — | 2 |
| Second Pass | | | | | | |
| N660 Carbon | — | 4 | 4 | 4 | 4 | 4 |
| Black | | | | | | |
| Aromatic Oil | — | 4 | 4 | 4 | 4 | 4 |
| Strontium | — | 100 | 100 | 100 | 100 | 100 |
| Ferrite | | | | | | |
| TESPT | — | — | 2 | 3 | 4 | — |
| TESPD | — | — | — | — | — | 2 |
| Third Pass | | | | | | |
| TBBS | .5 | .5 | .5 | .5 | .5 | .5 |
| Accelerator | | | | | | |
| Soluble Sulfur | 1.92 | 1.92 | 1.92 | 1.92 | 1.92 | 1.92 |

The ingredients used in Examples 5 and 6 and Comparative Examples A and B are summarized below in Table B.

TABLE B

| | | Comp. | | |
|---|---|---|---|---|
| | Comp. | Ex. B | Ex. 5 | Ex.6 |
| Ingredient | Ex. A | Sidewall A | Sidewall F | Sidewall G |
| First Pass | PHR | PHR | PHR | PHR |
| NR | 55 | 40 | 40 | 40 |
| High Cis BR | 45 | 60 | 60 | 60 |
| Strontium | — | 100 | 100 | 100 |
| Ferrite | | | | |
| TESPD | — | — | 4 | 6 |
| N660 Carbon | 52 | 48 | 48 | 48 |
| Black | | | | |
| Aromatic Oil | 16 | 12 | 12 | 12 |
| Tackifying | 3 | 3 | 3 | 3 |
| Resin | | | | |
| Antidgradants | 4.8 | 9.6 | 9.6 | 9.6 |
| Micro | 2.2 | 2.2 | 2.2 | 2.2 |
| crystalline | | | | |
| paraffin wax | | | | |
| Zinc Oxide | 2.7 | 2.7 | — | — |
| Stearic Acid | 2 | 2 | 2 | 2 |
| Second Pass | | | | |
| N660 Carbon | — | 4 | 4 | 4 |
| Black | | | | |
| Aromatic Oil | — | 4 | 4 | 4 |
| Zinc Oxide | — | — | 2.7 | 2.7 |
| Strontium | — | 100 | 100 | 100 |
| Ferrite | | | | |
| Third Pass | | | | |
| TBBS | .5 | .5 | .5 | .5 |
| Accelerator | | | | |
| Soluble | 1.92 | 1.92 | 1.92 | 1.92 |
| Sulfur | | | | |

The suppliers are listed below.

| | | Supplier Product |
|---|---|---|
| Ingredient Name | Supplier | Name |
| Strontium Ferrite, | Hoosier Magnetics, | Starbond Ferrite |
| 1.4 micron | Washington, | Powder HM181 |
| | Indiana | |
| TESPT | Degussa - Huels | Activator X50S |
| | AG, Kalscheuren, | |
| | Germany | |
| TESPD | CK Witco, Rock | Silquest A1589 |
| | Hill, SC | |
| Natural Rubber | Various Indonesian | SIR-20 |
| | Producers | |
| Polybutadiene | Bayer, Orange, | Taktene 1203G1 |
| | Texas | |
| | American Synthetic | Cisdene 1203 |
| | Rubber, | |
| | Louisville, KY | |
| | Goodyear Chemical, | Budene 1208 |
| | Beaumont, Texas | |
| | Bayer, Orange, | Buna CB25 |
| | Texas | |
| Carbon Black | Degussa, Aransas | N660 |
| | Pass, Texas | |
| | Alexandria Carbon | Continex N550 |
| | Black Co, | |
| | Alexandria, Egypt | |
| | Cabot, Waverly, WV | Vulcan M (N339) |
| Aromatic Oil | Sunoco, Inc., | Sundex 8125 |
| | Tulsa, OK | |
| Aliphatic/Hydro- | ExxonMobil, Baton | Escorez 1102 |
| carbon Resin | Rouge, LA | |
| | Totalfina, | Norsolene S95 |
| | Channelview, Texas | |
| Phenolic Resin | Schenectady | HRJ 10420 |
| | International, | |
| | Inc., Rotterdam | |
| | Junction, NY | |
| Antidegradants | Uniroyal Chemical, | Flexzone 4L |
| | Elmira, Ont, | |
| | Canada | |
| | Flexsys, Sauget, | Santoflex 6PPD PST |
| | IL | |
| Micro crystalline | AlliedSignal | Okerin 2027 |
| paraffin wax | Specialty | |
| | Chemicals, | |
| | Titusville, PA | |
| Zinc Oxide | Zinc Corporation | Kadox 720 |
| | of America, | |
| | Monaca, PA | |
| Stearic Acid | Witco, Mapleton, | Industrene R Flake |
| | IL | |
| Accelerator | Uniroyal Chemical, | Delac NS |
| | Geismer, LA | Millipellets |
| | | (TBBS) |
| | Uniroyal Chemical, | Delac S |
| | Geismer, LA | Millipellets (CBS) |
| Sulfur, soluble | Reagent Chemical, | Royal RM 90, .5% |
| | Middlesex, NJ | OT |
| Sulfur, oil | Flexsys, | Crystex HS OT 20 |
| treated | Monongahela, PA | |

### Evaluation

The sidewall composition of Examples 1-9 was evaluated for rubber deterioration according to the “Monsanto Fatigue to Failure” test which is based on a modified ASTM D4482-85 test method entitled “Standard Test Method for Rubber Property—Extension Cycling and Fatigue” as described below. The material of Examples 1-9 was also evaluated for Pierced DeMattia test according to a modified ASTM D813 test procedure entitled “Standard Test Method Rubber Deterioration—Crack Growth” as described below.

The “Monsanto Fatigue to Failure” test measures the fatigue life of cured rubber compounds when subjected to flexing at a known elongation. The equipment used is as follows: a Monsanto Fatigue to Failure Tester from Flexsys Co. formerly Monsanto, 2689 Windgate, Akron, Ohio; model FF-1; a fatigue specimen mold according to ASTM D4482; a calibration rod 60 mm from Flexsys Co., 2689 Windgate, Akron, Ohio; a fatigue specimen clicking die (Type E) from Hudson Die Group, Memorial Drive, Avon, Mass.; and a laboratory mill.

A 0.100±0.005″ thick sheet was prepared from uncured sidewall compositions of the Examples. The sheet was passed four times through the mill folding it back on itself after each pass, then conditioned for 1 to 24 hours at 73.4=/−5.4° F., prior to curing. The sheet was passed in the same direction to obtain the effect of mill direction, to develop the grain direction parallel to the length of the sheeted stock. Samples measuring 3″±0.025″×9.5″±0.025″, with the 9.5″side parallel to the grain of the stock were prepared and placed in the mold to cure at cured for 23 minutes at 160° C. Samples were conditioned at 73.40±5.4° F. for at least 24 hours.

The specimens for testing were prepared by die cutting at right angle to the grain (parallel to the 3″ side) using Type “E” die. Samples were run at an extension of 101% or an extension ratio of 2.01±0.05 by mounting cam number 14 on the machine. Samples were run at an extension of 136% or an extension ratio of 2.36±0.08 by mounting cam number 24 on the machine. The cams were fitted with the machine unloaded and the springs at the ends of the beams disconnected. The dynamic beams were moved upward and locked in the static position by pulling out the beam locks on the left hand side of the machine. The rear cam was fitted with its major axis in line with the key on the drive shaft and the front cam is fitted so that it is physically 180° out of phase with the rear cam The rear cam is mounted so that its major axis is in line with the key.

The specimens were mounted and the retaining clip turned 90° to secure. The machine was started and run until 80-100 appeared on the counters. The machine was then stopped. With the hand crank, the cam was rotated until zero strain was obtained.

With the thumb screw, each specimen was adjusted until it was subjected to a slight tension, then the tension was relieved until a slight bow in the specimen was just perceptible. The specimen has now been adjusted for permanent set. Then the machine was started. The application of zero strain and the tension were repeated every 24 hours until all specimens failed.

The DeMattia Test evaluates the ability of vulcanized rubber to resist dynamic fatigue. Specifically, the DeMattia flexing machine determines crack growth of vulcanized rubber when subjected to repeated bending strain or flexing. The following equipment was used: DeMattia E-Flexing Machine from Testing Machine Inc. 400 Bayview Ametyville N.Y.; piercing tool for puncturing specimens according to ASTM D-813; mold according to ASTM D813, a curing press capable of exerting a minimum force of 500 psi (3.45 Mpa) on the mold surface; a lab mill capable of maintaining a temperature +/−9° F. (5° C.) of set point, Gauge block, 2.56 in. +/−0.05 in. (65.0 mm +/−1.3 mm).

The sidewall composition of the examples was formed into sheets having a thickness of 0.275 in. +/−0.005 in. (7 mm +/−0.1 mm). The sheets were conditioned at 73.4° F. +/−5.4° F. (23° C. +/−3° C.) for 1 to 24 hours. Die cut specimens, 6 in.×1 in. (152.4 mm×25.4 mm), weighing 30+/−2 grams were prepared with the grain direction running parallel to the 6″ side of the die. The specimens were placed in a pre-heated mold, cured for 24 minutes at 160° C. under a pressure of at least 500 psi (3.45 Mpa) on the mold surface. Full pressure was applied and released three times to allow trapped air to escape. The specimens were removed from the mold, and submerged in tap water to cool. The edges of each specimen were trimmed to remove any overflow. Specimens having a groove surface free of irregularities or defects were selected. Thickness of the specimen is measured within 0.25 in. (6.4 mm) of the groove area and was 0.250 in. +/−0.005 in. (6.4 mm +/−0.1 mm). The specimens were then conditioned at room temperature for 12 hours. The specimens were pierced in the center of the groove and sample sides using the piercing tool to provide a hole 2.54 millimeters in diameter.

The machine was set up with distance between the stationary and moving grips was 075 in±0.01 in. (19.0±0.1 mm) when the grips are in their closest position and 2.99 in±0.1 in. (75.9+0.3 mm) when fully extended. The stationary and moving grips were parallel to each other in the closed and extended position. The specimens were loaded onto loading rack, the back cover of loading rack was replaced and tightened. The loading rack was placed between the stationary and movable grips in the DeMattia machine with the groove on the specimen was facing up. The grips on the stationary side were tightened until specimens were securely fastened. The movable grips were similarly tightened, and loading rack was removed.

During the testing procedure, readings were taken with the grips separated with a gauge block at 2.56 in. +/−0.05 in. (65.0 mm +/−1.3 mm). Measurements were taken on the following cycles: 1000, 1,500, 2,500, 5,000, 10,000, 20,000, 30,000, 40,000, 75,000, ;100,000. The test was terminated when 100,000 cycles were reached or when samples cracked across the entire width of specimen. The length of each crack in the groove of each specimen is measured and added to the 2.54 millimeter length of the pierced hole for each specimen.

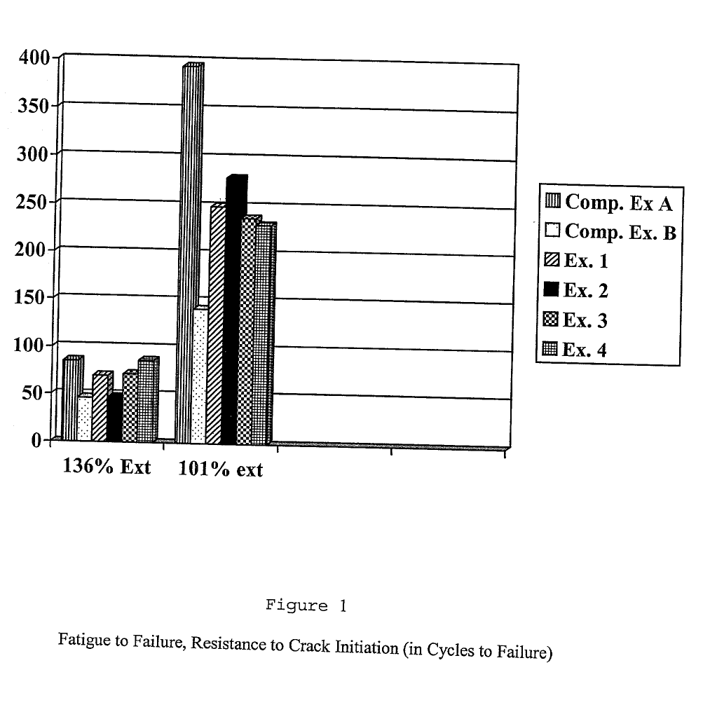

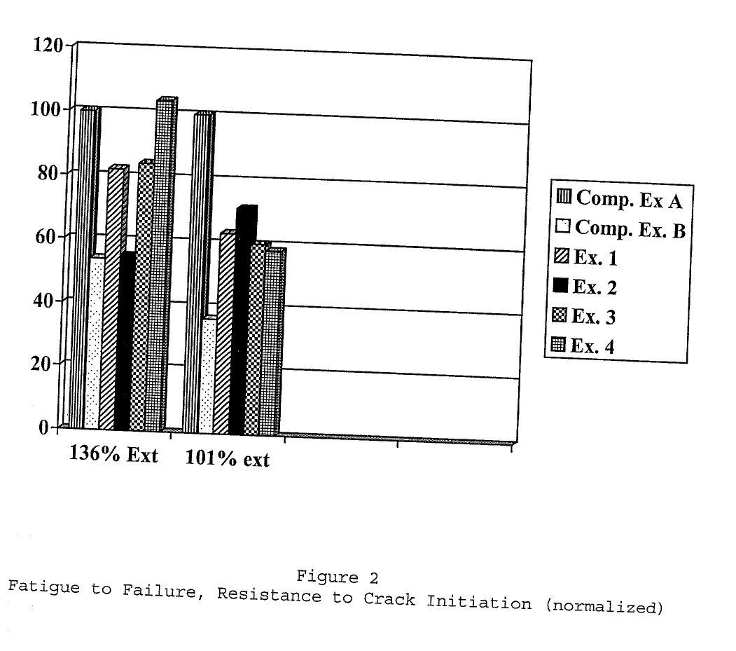

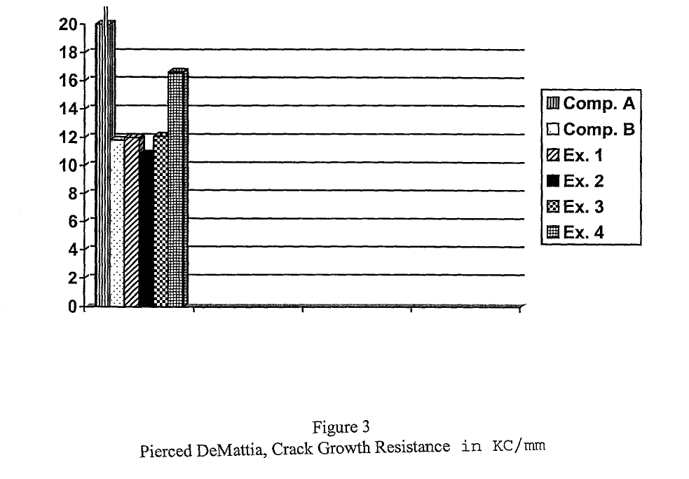

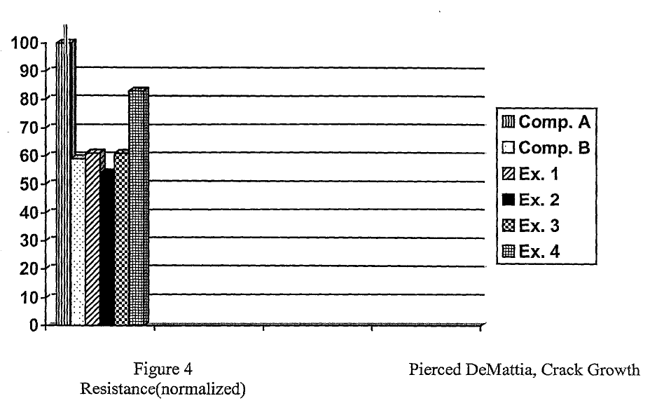

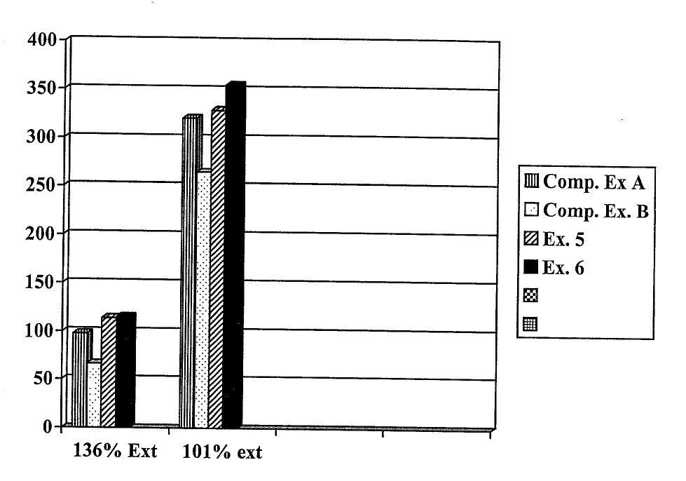

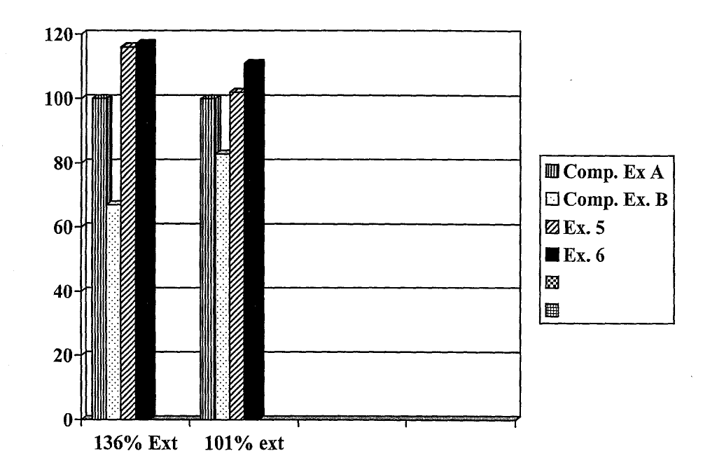

The performance of the sidewall compositions of Examples 1-4 were compared to the composition of Comparative Examples A and B. As shown in FIGS. 1 and 2, the organoxysilylsulfane significantly improves the fatigue life of the sidewall composition. As shown in FIGS. 3 and 4, there is a significant improvement in the growth crack resistance with the TESPD, and only a slight improvement with the TESPT.

The sidewall compositions of examples 5 and 6 were evaluated as above and compared to the composition of Comparative Examples A and C. As shown in FIGS. 5 and 6, the organoxysilylsulfane significantly improves the fatigue life of the composition. As shown in FIGS. 7 and 8, there is also an improvement in the growth crack resistance with the TESPD. The sidewall composition of Examples 7 to 9 was also evaluated but the results indicated that the presence of silica was less preferred.

The sidewall composition of Example 2 was used to form a 2 mil veneer coextruded onto a blackwall of an otherwise conventional 15 inch diameter tire, specifically a p235/75r15 extra load grapper tire using conventional techniques.

The 4 tires were subjected to a 72,000 kilometer test on a vehicle. The front tires were inflated to 26 psi; the rear tires were inflated to 35 psi and loaded to maximum. During the test the tires were periodically examined for the appearance of cracks. Three tires completed the test; one tire was removed for unrelated reasons. None of the tires displayed any cracks. One tire sidewall experienced a cut due to a road hazard at 18,000 km; no cracks propagated from this cut throughout the test.

The sidewall composition of Example 7 was also evaluated; the fatigue properties were not as good as the other examples suggesting a competition between the silica and strontium ferrite for the organosilane thiosester.

It is believed that the organoxysilylsulfane has potential binding sites on the strontium ferrite as indicated below:

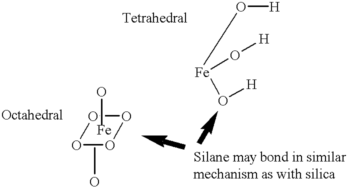

What is claimed is:

1. A sidewall composition comprising:
100 phr rubber;
30 to 350 phr of a magnetic particulate having a coercivity value of at least 30 KA/m;
0.5 to 30 of an organoxysilylsulfane; wherein the ratio of the magnetic particulate to the organoxysilylsulfane is 10:1 to 100:1, and
an effective amount of a curing agent to cure the rubber;
wherein the sidewall composition is magnetizable to a magnetic field strength of at least 0.01 Gauss, as measured at a distance of 8 mm for a 1 mm thick layer.

2. The sidewall composition of claim 1, wherein the sidewall composition has either: a fatigue to failure at 101% extension of 142 cycles or greater; or a pierced DeMattia resistance of 12 KC/mm or greater; or both.

3. The sidewall composition of claim 1, further comprising:
from 1 to 100 phr carbon black; wherein the magnetic particulate is a ferrite and the organoxysilylsulfane has the following structure: 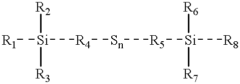
wherein:
R₁ is and ethoxy, methoxy, or hydroxy group;
R₂ is H ethoxy, methoxy, or hydroxy group;
R₃ is H ethoxy, methoxy, or hydroxy group;
R₄ is an alkyl group having at least one carbon atoms;
R₅ is an alkyl group having at least one carbon atoms;
R₆ is H, ethoxy, methoxy, or hydroxy group;
R₇ is H, ethoxy, methoxy, or hydroxy group;
R₈ is H, ethoxy, methoxy, or hydroxy group;
n is a number from 1 to 20.

4. The sidewall composition of claim 3, wherein R1 to R8 are ethoxy groups.

5. The sidewall composition of claim 3, the organoxysilylsulfane comprises triethoxy silyl propyl tetrasulfane and the magnetic particulate is strontium ferrite.

6. The sidewall composition of claim 3, wherein the organoxysilylsulfane comprises triethoxy silyl propyl disulfane and the magnetic particulate is strontium ferrite.

7. The sidewall composition of claim 3, wherein the rubber is comprised of 20 to 70 phr natural rubber, 20 to 70 phr butadiene rubber, 0 to 30% emulsion styrene butadiene rubber and the magnetic field strength is at least 0.5 Gauss.

8. A sidewall composition comprising:
100 phr rubber;
from 40 to 300 phr of a magnetic particulate having a coercivity value of at least 70 KA/m;
an effective amount of curing agents to cure the rubber;
from 15 to 70 phr carbon black;
from 1 to 20 phr of an organoxysilylsulfane having the following structure: 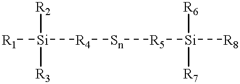
wherein:
R₁ is and ethoxy, methoxy, or hydroxy group;
R₂ is H ethoxy, methoxy, or hydroxy group;
R₃ is H ethoxy, methoxy, or hydroxy group;
R₄ is an alkyl group having from 1 to 40 carbon atoms;
R₅ is an alkyl group having from 1 to 40 carbon atoms;
R₆ is H, ethoxy, methoxy, or hydroxy group;
R₇ is H, ethoxy, methoxy, or hydroxy group;
R₈ is H, ethoxy, methoxy, or hydroxy group; and
n is a number from 1 to 20;
wherein the ratio of the magnetic particulate to the organoxysilylsulfane is 25:1 to 75:1,
wherein the sidewall composition is magnetizable to a magnetic field strength of at least 0.01 Gauss, as measured at a distance of 8 mm for a 1 mm thick layer.

9. The sidewall composition of claim 8, wherein the rubber is comprised of 20 to 70 phr natural rubber, 20 to 70 phr butadiene rubber, 1 to 30% emulsion styrene butadiene rubber; the magnetic particulate is strontium ferrite, and the organoxysilylsulfane comprises triethoxy silyl propyl tetrasulfane.

10. The sidewall composition of claim 8, wherein the rubber is comprised of 20 to 70 phr natural rubber, 20 to 70 phr butadiene rubber, 1 to 30% emulsion styrene butadiene rubber; the magnetic particulate is strontium ferrite and organoxysilylsulfane comprises triethoxy silyl propyl disulfane.

11. The sidewall composition of claim 10, wherein the sidewall composition has either: a fatigue to failure at 101% extension of 200 cycles or greater; or a pierced DeMattia resistance of 15 KC/mm or greater; or both.

12. The sidewall composition of claim 10, wherein the sidewall composition has either: a fatigue to failure at 101% extension of 266 cycles or greater; or a pierced DeMattia resistance of 29 KC/mm or greater; or both.

13. A sidewall composition comprising:
100 phr rubber;
from 50 to 250 phr of a ferrite magnetic particulate having a coercivity value of at least 100 KA/m;
from 2 to 10 phr of a triethoxysilylsulfane; wherein the ratio of the magnetic particulate to the organoxysilylsulfane is 45:1 to 55:1;
an effective amount of curing agents to cure the rubber; from 25 to 60 phr carbon black;
wherein the sidewall composition is magnetizable to a magnetic field strength of at least 0.01 Gauss, as measured at a distance of 8 mm for a 1 mm thick layer.

14. The sidewall composition of claim 13, further comprising:
from 0.1 to 40 phr processing oil;
from 0.1 to 12 phr stearic acid;
from 0.1 to 16 phr zinc oxide;
from 0.1 to 16 phr tackifying resin;
from 0.1 to 20 phr antidegradants;
from 0.1 to 16 phr microcrystalline paraffin wax; and
from 0.1 to 8 phr cure accelerator;
wherein:
the magnetic particulate is strontium ferrite.

15. The sidewall composition of claim 13, wherein the rubber is comprised of 20 to 70 phr natural rubber, 20 to 70 phr butadiene rubber, 1 to-30% emulsion styrene butadiene rubber; and the organoxysilylsulfane comprises triethoxy silyl propyl tetrasulfane.

16. The sidewall composition of claim 13, wherein the rubber is comprised of 20 to 70 phr natural rubber, 20 to 70 phr butadiene rubber, 1 to 30% emulsion styrene butadiene rubber; and organoxysilylsulfane comprises triethoxy silyl propyl disulfane.

17. A tire, comprising:
a tread,
a shoulder, attached to the tread;
a sidewall attached to the shoulder;
wherein the sidewall has a magnetic field strength of preferably at least 0.01 Gauss, as measured at a distance of 8 mm for a 1 mm thick layer, and
said sidewall is comprised of:
100 phr cured rubber;
from 30 to 350 phr of a magnetic particulate having a coercivity value of at least 50 KA/m;
0.5 to 30 phr of an organoxysilylsulfane;
wherein the ratio of the magnetic particulate to the organoxysilylsulfane is 10:1 to 100:1.

18. The tire of claim 17, wherein the sidewall composition has either: a fatigue to failure at 101% extension of 142 cycles or greater; or a pierced DeMattia resistance of 12 KC/mm or greater; or both.

19. The tire of claim 17, wherein: the sidewall composition further comprises:
from 10 to 100 phr carbon black;
the magnetic particulate is a ferrite and the organoxysilylsulfane has the following structure: 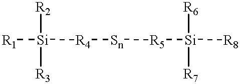
wherein:
R₁ is and ethoxy, methoxy, or hydroxy group;
R₂ is H ethoxy, methoxy, or hydroxy group;
R₃ is H ethoxy, methoxy, or hydroxy group;
R₄ is an alkyl group having at least one carbon atoms;
R₅ is an alkyl group having at least one carbon atoms;
R₆ is H, ethoxy, methoxy, or hydroxy group;
R₇ is H, ethoxy, methoxy, or hydroxy group;
R₈ is H, ethoxy, methoxy, or hydroxy group; and
n is a number from 1 to 20.

20. The tire of claim 19, wherein R1 to R8 are ethoxy groups.

21. The tire of claim 19, wherein the organoxysilylsulfane comprises triethoxy silyl propyl tetrasulfane and the magnetic particulate is strontium ferrite.

22. The tire of claim 19, wherein the organoxysilylsulfane comprises triethoxy silyl propyl disulfane and the magnetic particulate is strontium ferrite.

23. The tire of claim 19, wherein the rubber is comprised of 20 to 70 phr natural rubber, 20 to 70 phr butadiene rubber, 1 to 30% emulsion styrene butadiene rubber and the magnetic field strength is at least 0.5 Gauss.

24. A tire comprising:
a tread,
a shoulder, attached to the tread;
a sidewall attached to the shoulder;
wherein the sidewall has a magnetic field strength of at least 0.01 Gauss, as measured at a distance of 8 mm for a 1 mm thick layer;
said sidewall is comprised of: 100 phr cured rubber;
40 to 300 phr of a magnetic particulate having a coercivity value of at least 70 KA/m;
from 15 to 70 phr carbon black;
1 to 20 phr of an organoxysilylsulfane having the following structure: 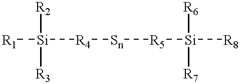
wherein:
R₁ is and ethoxy, methoxy, or hydroxy group;
R₂ is H ethoxy, methoxy, or hydroxy group;
R₃ is H ethoxy, methoxy, or hydroxy group;
R₄ is an alkyl group having from 1 to 40, carbon atoms;
R₅ is an alkyl group having from 1 to 40, carbon atoms;
R₆ is H, ethoxy, methoxy, or hydroxy group;
R₇ is H, ethoxy, methoxy, or hydroxy group;
R₈ is H, ethoxy, methoxy, or hydroxy group; and
n is a number from 1 to 8;
wherein the ratio of the magnetic particulate to the organoxysilylsulfane is 25:1 to 75:1.

25. The tire of claim 24, wherein the rubber is comprised of 20 to 70 phr natural rubber, 20 to 70 phr butadiene rubber, 1 to 30% emulsion styrene butadiene rubber; the magnetic particulate is strontium ferrite, and the organoxysilylsulfane comprises triethoxy silyl propyl tetrasulfane.

26. The tire of claim 24, wherein the rubber is comprised of 20 to 70 phr natural rubber, 20 to 70 phr butadiene rubber, 1 to 30% emulsion styrene butadiene rubber; the magnetic particulate is strontium ferrite and organoxysilylsulfane comprises triethoxy silyl propyl disulfane.

27. A tire comprising:
a tread,
a shoulder, attached to the tread;
a sidewall attached to the shoulder;
wherein the sidewall has a magnetic field strength of at least 0.01 Gauss, as measured at a distance of 8 mm for a 1 mm thick layer; and said sidewalls are comprised of:
100 phr cured rubber;
50 to 250 phr of a ferrite magnetic particulate having a coercivity value of at least 100 KA/m;
2 to 10 phr of a triethoxysilylsulfane, wherein the ratio of the magnetic particulate to the organoxysilylsulfane is 45:1 to 55:1;
25 to 60 phr carbon black.

28. The tire of claim 27, further comprising:
from 0.1 to 40 phr processing oil;
from 0.1 to 12 phr stearic acid;
from 0.1 to 16 phr zinc oxide;
from 0.1 to 16 phr tackifying resin;
from 0.1 to 20 phr antidegradants;
from 0.1 to 16 phr microcrystalline paraffin wax; and
from 0.1 to 8 phr cure accelerator;
wherein:
the magnetic particulate is strontium ferrite and the sidewall composition has either: a fatigue to failure at 101% extension of 142 cycles or greater; or a pierced DeMattia resistance of 12 KC/mm or greater; or both.

29. The tire of claim 27, wherein the rubber is comprised of 20 to 70 phr natural rubber, 20 to 70 phr butadiene rubber, 1 to 30% emulsion styrene butadiene rubber; and the organoxysilylsulfane comprises triethoxy silyl propyl tetrasulfane.

30. The tire of claim 27, wherein the rubber is comprised of 20 to 70 phr natural rubber, 20 to 70 phr butadiene rubber, 1 to 30% emulsion styrene butadiene rubber; and organoxysilylsulfane comprises triethoxy silyl propyl disulfane.

31. A method for preparing a sidewall composition comprising the following steps:
a. providing 100 parts rubber and from 30 to 350 phr magnetic particulate and from 0.5 to 30 phr organoxysilylsulfane wherein the ratio of the magnetic particulate to the organoxysilylsulfane is 10:1 to 100:1;
b. combining the rubber with 15% to 50% of the magnetic particulate to form a first mixture;
c. combining the first mixture with 25% to 75% of the organoxysilylsulfane and 15% to 50% of the magnetic particulate to form a second mixture;
d. combining the remaining 25% to 75% of the magnetic particulate, and 25% to 75% of the organoxysilylsulfane, with the second mixture to form a third mixture; and
e. adding curing agents to the third mixture in an amount effective to cure the rubber.

32. The method of claim 31, further comprising the step of adding tackifying resin, antidegradants, carbon black, to the first mixture;
adding microcrystalline wax, stearic acid, to the second mixture;
adding processing oil to the mixture after adding the microcrystalline wax, and stearic acid.

33. The method of claim 31, wherein 20% to 30% of the magnetic particulate is added to form the first mixture,
wherein 45% to 550 of the organoxysilylsulfane and 20% to 30% of the magnetic particulate are added to form the second mixture;
wherein 45% to 55%, of the magnetic particulate, and 45% to 55%, of the organoxysilylsulfane, are added to form the third mixture.

34. The method of claim 33, wherein the organooxysilysulfane comprises triethoxy silyl propyl tetrasulfane and the magnetic particulate is a ferrite magnetic particulate.

35. The method of claim 33, wherein the organooxysilysulfane comprises triethoxy silyl propyl disulfane and the magnetic particulate is a ferrite magnetic particulate.

36. A method for preparing a sidewall composition comprising the following steps:
a. providing 100 parts rubber and 30 to 350 phr magnetic particulate and from 0.5 to 30 phr organoxysilylsulfane; wherein the ratio of the magnetic particulate to the organoxysilylsulfane is 10:1 to 100:1;
b. combining the rubber with 50% to 100% of the organoxysilylsulfane and 25% to 75% of the magnetic particulate to the rubber to form a first mixture;
c. combining 25% to 75%, of the magnetic particulate, and 0 to 50% of the organoxysilylsulfane, with the first mixture to form a second mixture; and
d. adding curing agents to the third mixture in an amount effective to cure the rubber.

37. The method of claim 36, further comprising the steps of adding:
from 0.1 to 8 phr stearic acid;
from 0.1 to 10 phr zinc oxide;
from 0.1 to 10 phr tackifying resin;
from 0.1 to 14 phr antidegradants;
from 0.1 to 10 phr microcrystalline paraffin wax; and
from 0.1 to 100 phr carbon black,
to the first mixture; then adding a from 0.1 to 24 phr processing oil.

38. The method of claim 36, wherein
90% to 100% of the organoxysilylsulfane and 45% to 55% of the magnetic particulate are added to form the first mixture;
and 45% to 55% of the magnetic particulate, and 0 to 10% of the organoxysilylsulfane, are added to form the second mixture.

39. The method of claim 38, wherein the magnetic particulate is a ferrite and the organoxysilylsulfane has the following structure: 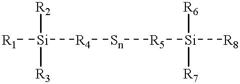
wherein:
R₁ is and ethoxy, methoxy, or hydroxy group;
R₂ is H ethoxy, methoxy, or hydroxy group;
R₃ is H ethoxy, methoxy, or hydroxy group;
R₄ is an alkyl group having at least one carbon atom;
R₅ is an alkyl group having at least one carbon atoms;
R₆ is H, ethoxy, methoxy, or hydroxy group;
R₇ is H, ethoxy, methoxy, or hydroxy group;
R₈ is H, ethoxy, methoxy, or hydroxy group;
n is a number from 1 to 20.

40. The method of claim 39, wherein the organoxysilylsulfane comprises triethoxy silyl propyl tetrasulfane.

41. The method of claim 39, wherein the organoxysilylsulfane comprises triethoxy silyl propyl disulfane.
